(19) United States
(12) Patent Application Publication
(10) Pub. No.: US 2019/0302949 A1
(43) Pub. Date: Oct. 3, 2019

(54) METHODS AND SYSTEMS FOR ENHANCED FORCE-TOUCH BASED GESTURE SOLUTIONS

(71) Applicant: MaxLinear, Inc., Carlsbad, CA (US)

(72) Inventors: Curtis Ling, Carlsbad, CA (US); James Lougheed, Carlsbad, CA (US); Paul (Gun Ho) Hong, San Diego, CA (US)

(21) Appl. No.: 16/372,904

(22) Filed: Apr. 2, 2019

Related U.S. Application Data
(60) Provisional application No. 62/651,397, filed on Apr. 2, 2018.

(51) Int. Cl. G06F 3/041; A63F 13/2145; G06F 1/16

(52) U.S. Cl. CPC G06F 3/0414; A63F 13/2145; G06F 1/1643; G06F 1/1686; G06F 3/0416

(57) ABSTRACT

Systems and methods are provided for enhanced force-touch based gesture solutions. A handheld electronic device may include a plurality of force-touch sensors integrated into the body of the electronic device and one or more control circuits. Each force-touch sensor is configured to generate sensory signals in response to application of a force to an area of the body of the electronic device corresponding to that force-touch sensor. The one or more control circuits are configured to control based on sensory signals, operations and/or functions in the electronic device. The controlling may include generating based on the sensory signals, one or both of control information for controlling or managing at least one of the operations and/or functions in the electronic device and an input to at least one of the operations and/or functions in the electronic device.

### CLAIM OF PRIORITY

This patent application makes reference to, claims priority to and claims benefit from U.S. Provisional Patent Application Ser. No. 62/651,397, filed on Apr. 2, 2018. The above identified application is hereby incorporated herein by reference in its entirety.

### BACKGROUND

Aspects of the present disclosure relate to electronic devices and solutions relating thereto. More specifically, implementations in accordance with present disclosure relate to methods and systems for enhanced force-touch based gesture solutions.

Limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for enhanced force-touch based gesture solutions, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates example electronic device that may configured to implement and support enhanced force-touch based gesture solutions.

FIG. 2 illustrates an example force-touch based architecture for use in electronic devices, which may be used in conjunction with enhanced force-touch based gesture solutions.

FIG. 3 illustrates an example conventional force-touch (FT) sensor architecture, which may be used in conjunction with enhanced force-touch based gesture solutions.

FIG. 4 illustrates an example integrated force-touch (FT) sensor architecture, which may be used in conjunction with enhanced force-touch based gesture solutions.

FIG. 5 illustrates an example integrated force-touch (FT) multi-sensor configuration, which may be used in conjunction with enhanced force-touch based gesture solutions.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

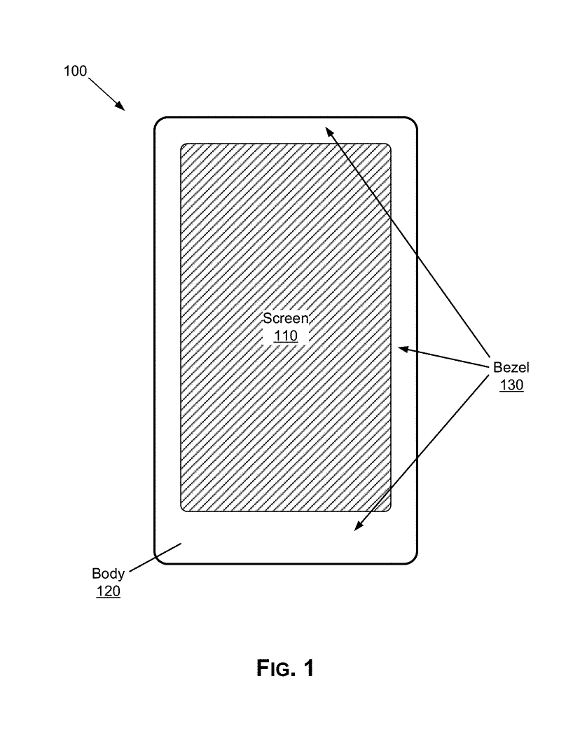

FIG. 1 illustrates example electronic device that may configured to implement and support enhanced force-touch based gesture solutions. Shown in FIG. 1 is electronic device 100.

The electronic device 100 may comprise suitable circuitry for performing various functions or operations, and/or run various applications and/or programs. In this regard, operations, functions, applications and/or programs supported by the electronic device 100 may be performed, executed and/or run based on user instructions and/or pre-configured instructions. Examples of electronic devices may comprise handheld devices (e.g., cellular phones, smartphones, tablets, remote controls, cameras, gaming controllers, etc.). The disclosure, however, is not limited to any particular type of electronic device.

The electronic device 100 may incorporate components or subsystems for generating and/or obtaining certain information. For example, the electronic device 100 may comprise dedicated components enabling interactions with users, such as for receiving user input and/or providing user output, particularly based on the supported types of input and/or output in the device. In this regard, various types of output/input may be supported, including (but not limited to) audible, visual, textual, etc.

In some instances, electronic devices (such as the electronic device 100) may be configured for receiving touch-based user input—that is, input that is provided by means of the user interacting with the electronic devices by touching the electronic devices or component thereof in particular way. In this regard, the electronic devices may incorporate sensory means for detecting forces applied by the user, and then process the corresponding sensory data in order to interpret user's interactions—e.g., to determine what (if any) input the user is attempting to provide. In many instances, this may be done using touchscreens.

In this regard, many electronic devices may incorporate a screen (e.g., screen 110 in the electronic device 100), which may be used to provide visual output (e.g., video, still images, graphic user interface, etc.). Such screens may be configured as touchscreens—that is, being configured to receive input based on user interactions with the screen. Examples of possible types of input that may be provided via such touchscreens may include tapping, pressing, sliding, etc. The combination of the form of the interaction and the particular region where the interaction is made may be used when determining whether (or not) the user is attempting to provide a particular input, and how to interpret such input.

In some instances, electronic devices may be configured to also support receiving touch-based user input applied to areas other than the screen—e.g., to the body 120 of the electronic device 1, especially the areas corresponding to the so-called “bezel” (particularly in the context of smartphones, tablets, etc.), which typically includes all of the non-screen space on the front and/or side(s). This may be done by incorporating into body 120 components for sensing and detecting physical contact between the user and the body 120 (e.g., in the form of touching, and changes thereto), and then processing any detected contact to assess whether or not it corresponds to intended input.

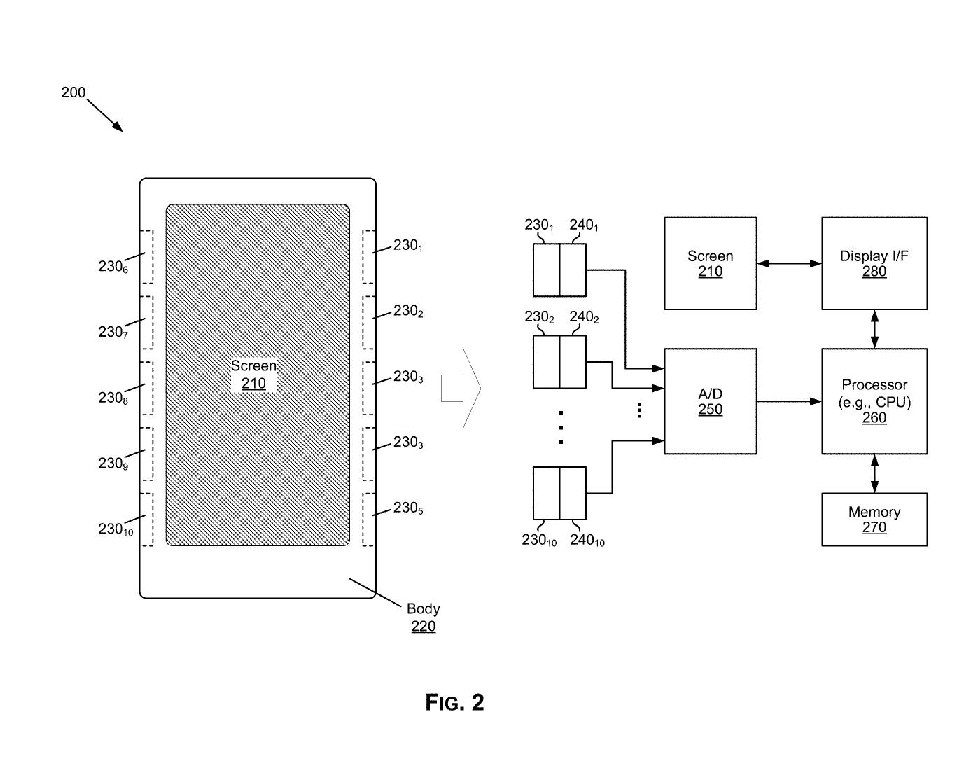

For example, the bezel 130 in the electronic device 110 may incorporate force-touch based sensory components embedded therein, which may be configured to detect when the user applies force into the bezel 130, and generate corresponding sensory data. The sensory data may then be processed, to determine if it constitutes intended user input or not—for example, based on thresholds to differentiate between normal forces (e.g., forces applied when holding the electronic device) and forces intended as user input. An example electronic device incorporating force-touch architecture is shown and described with respect to in FIG. 2.

In various implementations in accordance with the present disclosure, electronic devices such as the electronic device 100 may be configured to support enhanced force-touch based gesture solutions. In this regard, the electronic devices may incorporate suitable components and/or circuits for detecting complex touch-based user interactions with the electronic device, and for processing these interactions, such as to interpret them as user input.

This may be done by incorporating into the body of the electronic device—that is, into areas other than the screen, sensory related components that may detect user's touches and/or changes thereto (e.g., by position and/or movement of fingers in relation to the body of the electronic device), which may generated corresponding sensory information that are in turn processed to determine when it indicate particular user input, and what that input may be. The complex touch-based interactions may be defined based on various criteria, such as: 1) type or form of interaction (e.g., grip, squeeze, slide, etc.), 2) location (e.g., where the touch is being applied), 3) whether or not a sequence of interactions is performed (if so, details on each of interactions in the sequence), and the like.

Examples of interactions that may be supported are described below. The particular sensory components utilized and/or the particular manner in which the sensory components are incorporated may vary between different implementations. Examples of such variations are described below with respect to FIGS. 2-5.

The electronic device may be programmed to handle these touch-based interactions. Further, in some instances, the touch-based related functions may be configurable and/or controllable by the user. For example, users may be able to assign different inputs to particular interactions, may be able to turn on/off certain interactions, may alter or modify some of the interactions, etc.

In an example implementation, the enhanced force-touch based gestures may comprise “double tap” based gestures. In this regard, double tap is a variant of variant of squeeze and grip, and include performing quick double squeeze. To do so, the electronic devices may be configured for requiring Quick double squeezes (e.g., double tap start up on back of phone). For example, where the electronic device comprises a phone (or similar device), the double tap may comprise a movement back on the phone, going from top the phone or base of the phone—e.g., a slide-like movement, but in a different direction; in a horizontal direction.

In an example implementation, the enhanced force-touch based gestures may comprise “xswipe” based gestures. In this regard, where the electronic device comprises a phone (or similar device), an xswipe may comprise a swipe (or slide) movement on edge of phone, such as from front of phone to back of phone (perpendicular to face of phone).

In an example implementation, the enhanced force-touch based gestures may comprise scroll based gestures. In this regard, scroll gestures may be a variant of slide gestures. In particular, scroll gestures may comprise multiple slide movements in the same direction. Thus, the electronic device may recognize a gesture as a scroll based on detecting the user applying a slide in one direction and then going back and sliding again and again in the same direction. For example, while viewing an email or webpage, the user may scroll by sliding fingers repeatedly along edge of the phone (upward or downward directions).

In an example implementation, the enhanced force-touch based gestures may comprise multi-finger based gestures. In this regard, the electronic device may be configured for multi-finger recognition—that is, recognition of various common hand positions or patterns. For example, multi-finger recognition may comprise recognition of the device being held in the user's left or right hand, and accordingly applying different modes, such as to (re-)configure existing buttons (e.g., rocker switch power and volume control buttons) from one side to the other side of the phone (e.g., from smartphone's right side to left side or vice versa move). This may allow adaptively accommodating left-handed and right-handed users).

The multi-finger recognition function may also comprise recognition of particular holding positions, which may be used (on its own and/or in conjunction with running applications) as indicative of desired actions—that is, the position and/or movement of the fingers may be interpreted in the context of the application run at the time. In this regard, knowledge of what the device is being used to do at the time (e.g., based on the application(s) running) may be combined with sensory information corresponding to the user's handling/holding of the phone to determine and/or interpret the user's input/commands. For example, such recognition of particular holding positions may be used in conjunction with the camera application to allow for enhance camera operations. In an example use scenario, upon recognition, slide and squeeze gestures may be used to performed different camera functions—e.g., slide for zoom when taking photos, squeeze in specific bezel areas for triggering photos.

In an another use scenario, the multi-finger recognition may allow determining when a user is holding a phone in a position typical of taking photos, and also distinguish between taking photos facing away from user versus taking selfie photos, which may be used to automatically activate rear or front cameras respectively. In an example implementation, the recognition of particular holding positions may allow for determining when the user is attempting to take a selfie. This may be particularly possible where each edge of the phone is entirely covered with sensors, thus making the entire edges force-touch sensitive.

For example, it may be determined when the user is attempting to take a selfie based on a number of actions or indicia—e.g., the camera application being activated, the phone facing toward the user, etc. Thus, to obviate the need to move the fingers in a manner that may affect focus of the camera, a particular multi-finger position or movement may be used to trigger taking the selfie instead—e.g., a squeeze, and immediately use that as your instruction to take the photo. So it's kind of intelligent contact sensitive squeeze action. The multi-finger recognition may also allow for disguising between selfie and normal picture attempts.

For example, when users are taking a picture with the face-forward hand position, they would have both their hands on the edge of the phone (e.g., with one finger on each corner of the phone being a common photo taking gesture). When attempting to take a selfie, however, users typically use one hand (e.g., with one or two fingers on the top edge, and one or two fingers on the bottom edge). Thus, once the fingers are detected and the particular pattern is matched, the camera may be configured for face-forward or selfie modes.

The multi-finger recognition may also allow for determining when the user is taking the pictures. For example, picture taking may be done in response to the user performing a particular gesture, such as squeezing, which may detected based on a change in the force. The force may have to exceed a particular threshold, to avoid accidentally taking pictures.

The multi-finger recognition may also allow for determining when to use the front or back camera (independent of whether the user is taking face-forward or selfie pictures). Thus, by detecting how the user is holding the phone—e.g., whether the user has the front or back of the phone facing the user, it may be determined which camera to use (which may also be determined based on whether a selfie is being taken or not, as described above).

The multi-finger recognition may also allow for determining when the user is zooming during use of the camera. The slide gestures may be used to zoom in and out (e.g., using a thumb on the bottom right corner, etc.). Similar gestures may also be used to perform other adjustments, such as exposure, focal point selection, etc. These selections may also vary based whether the camera is determined to be operated in selfie mode, or face-forward mode.

In an example implementation, the enhanced force-touch based gestures may comprise “double tap” based gestures. In this regard, double tap is a variant of variant of squeeze and grip, and include performing quick double squeeze. To do so, the electronic devices may be configured for requiring quick double squeezes (e.g., double tap start up on back of phone). For example, where the electronic device comprises a phone (or similar electronic device), the double tap may comprise a movement back on the phone, going from top the phone or base of the phone—e.g., a slide-like movement, but in a different direction; in a horizontal direction.

In an example implementation, the enhanced force-touch based gestures may comprise “xswipe” based gestures. In this regard, where the electronic device comprises a phone (or similar electronic device), an xswipe may comprise a swipe (or slide) movement on edge of phone, such as from front of phone to back of phone (perpendicular to face of phone).

In an example implementation, the enhanced force-touch based gestures may comprise scroll based gestures. In this regard, scroll gestures may be a variant of slide gestures. In particular, scroll gestures may comprise multiple slide movements in the same direction. Thus, the electronic device may recognize a gesture as a scroll based on detecting the user applying a slide in one direction and then going back and sliding again and again in the same direction. For example, while viewing an email or webpage, the user may scroll by sliding fingers repeatedly along edge of the phone (upward or downward directions).

In an example implementation, the enhanced force-touch based gestures may comprise multi-finger based gestures. In this regard, the electronic device may be configured for multi-finger recognition—that is, recognition of various common hand positions or patterns. For example, multi-finger recognition may comprise recognition of the electronic device being held in the user's left or right hand, and accordingly applying different modes, such as to (re-)configure existing buttons or user controls (e.g., power, volume, etc.) from one side to the other side of the phone (e.g., from smartphone's right side to left side or vice versa move). This may allow adaptively accommodating left-handed and right-handed users).

The multi-finger recognition function may also comprise recognition of particular holding positions, which may be used (on its own and/or in conjunction with running applications) as indicative of desired actions—that is, the position and/or movement of the fingers may be interpreted in the context of the application run at the time. In this regard, knowledge of what the electronic device is being used to do at the time (e.g., based on the application(s) running) may be combined with sensory information corresponding to the user's handling/holding of the phone to determine and/or interpret the user's input/commands. For example, such recognition of particular holding positions may be used in conjunction with the camera application to allow for enhance camera operations. In an example use scenario, upon recognition, slide and squeeze gestures may be used to performed different camera functions—e.g., slide for zoom when taking photos, squeeze in specific bezel areas for triggering photos.

In an another use scenario, the multi-finger recognition may allow determining when a user is holding phone in a position typical of taking photos, and also distinguish between taking photos facing away from user versus taking selfie photo, which may be used to automatically activate rear or front cameras respectively. In an example implementation, the recognition of particular holding positions may allow for determining when the user is attempting to take a selfie. This may be particularly possible where each edge of the phone is entirely covered with sensors, thus making the entire edges force-touch sensitive.

For example, it may be determined when the user is attempting to take a selfie based on a number of actions or indicia—e.g., the camera application being activated, the phone facing toward the user, etc. Thus, to obviate the need to move the fingers in a manner that may affect focus of the camera, a particular multi-finger position or movement may be used to trigger taking the selfie instead—e.g., a squeeze, and immediately use that as your instruction to take the photo. So it's kind of intelligent contact sensitive squeeze action. The multi-finger recognition may also allow for disguising between selfie and normal picture attempts.

For example, when users are taking a picture with the face-forward hand position, they would have both their hands on the edge of the phone (e.g., with one finger on each corner of the phone being a common photo taking gesture). When attempting to take a selfie, however, users typically use one hand (e.g., with one or two fingers on the top edge, and one or two fingers on the bottom edge). Thus, once the fingers are detected and the particular pattern is matched, the camera may be configured for face-forward or selfie modes.

The multi-finger recognition may also allow for determining when the user is taking the pictures. For example, picture taking may be done in response to the user performing a particular gesture, such as squeezing, which may detected based on a change in the force. The force may have to exceed a particular threshold, to avoid accidentally taking pictures.

The multi-finger recognition may also allow for determining when to use the front or back camera (independent of whether the user is taking face-forward or selfie pictures). Thus, by detecting how the user is holding the phone—e.g., whether the user has the front or back of the phone facing the user, it may be determined which camera to use (which may also be determined based on whether a selfie is being taken or not, as described above).

The multi-finger recognition may also allow for determining when the user is zooming during use of the camera. The slide gestures may be used to zoom in and out (e.g., using a thumb on the bottom right corner, etc.). Similar gestures may also be used to perform other adjustments, such as exposure, focal point selection, etc. These selections may also vary based whether the camera is determined to be operated in selfie mode, or face-forward mode.

In an example implementation, enhanced force-touch based gestures and related functions may be configurable. In this regard, users may be able to configure the sensory functions, such as based on a user's preferences. Such configurability may be used alone, and may also be used in with existing configurability/adaptiveness associated with certain gestures, such as multi-finger gestures (e.g., re-configuring buttons or user controls based on determination whether the user is left-handed or right-handed from the way the electronic device is held). For example, users may be able to adjust the manner by which certain actions or inputs are made based on interactions with the electronic device. Rather than taking face-forward picture by placing four fingers (one on each corner of the electronic device), for example, picture may be taken by holding the electronic device with two fingers and then sliding a figure along the bottom (or top) edge of the electronic device.

Users may configure the electronic device and/or sensory functions thereof any way they want—that is, in accordance with their own preferences, which may allow different users to associate the same action (e.g., taking selfie pictures and/or videos, assigning particular user control element (e.g., button, switch, etc.) and/or gesture with particular function, such as powering on/off the electronic device, etc.) with different gestures, positions, and/or sequence of sensory-related interactions. Such associating of a particular action with particular gestures, positions, and/or sequence may be done in various ways. For example, a user may hold the electronic device in a particular position, and then associate that position with a particular action.

The associating itself may be done in different ways, such as by interacting with the electronic device in a manner that would allow assigning the position. For example, in suitable electronic devices, this may be done by issue an audible command to do so while holding the electronic device in the desired position, may be done by using. In another example, the user may simply instruct the electronic device (e.g., using audible command, by selection via interactive menus, etc.) to define a particular gesture to mean something.

In an example implementation, force-touch sensors and enhanced force-touch functions based thereon may be configured for operation in conjunction with other sensors. In this regard, force-touch sensors may be configured for operation in conjunction with other sensors in the electronic device, such as temperature sensors, position sensors, etc. For example, temperature sensors may be used to determine when the electronic device is (or is not) in contact with the user's body (e.g., based on measured temperatures corresponding to body temp, or not). This may indicate when a smartphone is, for example, placed in the user's pocket or on the user's body, which may allow interpreting forces or gestures different—e.g., based on pre-defined criteria.

Position sensors and readings thereby may allowing determining, for example, when the device is tilted or moved in particular manner, which may allow interpreting gestures accordingly.

In an example implementation, enhanced force-touch based functions may be configured for sensing bendable screen position via force. In this regard, sensors may be used to determine, based on measured force, quality of the folded or bendable screens.

In an example implementation, sensory functions may be configured for recognition of particular types of non-touch contact in the electronic device. This may allow recognizing when an electronic device is placed or position in certain manner, attached to particular item, etc. Thus, where the electronic device comprises a smartphone, for example, this may allow recognizing when the smartphone is placed in a car cupholder or phone-holder, is placed on a tripod, is mount is attached to a selfie-stick, etc. In this regard, the sensory functions may be configured to determine positioning and/or placement of the electronic device based on sensory information indication points of contact or no contact on the various edges of the electronic device.

For example, detection of no points of contact on edges of phone, but on back (or front) of the electronic device may allow determining that the electronic device is placed flat on a surface (e.g., a table or desk). Similarly, it may be determined when an electronic device (e.g., smartphone) is placed in a car cupholder when there is contact on the bottom edge with contact being made (continually or intermittently) on either side of the phone. Further, the electronic device may be configured to action differently on basis of the determined non-touch contact.

In an example implementation, enhanced force-touch based gestures and related functions may be configured to enable recognizing handling of the electronic device in particular manner—e.g., recognition of the electronic device (e.g., a smartphone) being pulled or slipped into user's pocket, recognition of the electronic device being held while the user is moving (e.g., walking, running, etc.) or not, and the like. For example, recognition of the electronic device being pulled or slipped in the pocket may be based on sensory information indicating contact with the user's hand, contact with clothing, and/or positioning of the phone in relation to the user's body. Recognition of whether the user is walking or running may be based on particular sensory information associated with such actions—e.g., as such acts produce a certain recognizable jarring motion that may result in sensory information having particular characteristics or patterns.

In an example implementation, enhanced force-touch based gestures and related functions may be configured for use to provide strength/impact based applications. For example, force-touch sensory functions may be configured to enable use the electronic devices, for example, for obtaining and recording strength measurements—e.g., by measuring user's strength based on sensory information generated in response to the user's grip on the electronic device. This may be done in such electronic devices as smartphones and like electronic devices, for example, to provide users with convenient way for take strength measurements, such as for daily tracking.

In some instances, these measurements may be provided to remote health care providers, such as for use in diagnostics and/or in the course of regular medical checkups. In some instances, the force measurements may allow use of the electronic devices as improvised “scales” (where the electronic devices are strong enough to take the weight of a person). For example, when possible, a user may stand on his/her smartphone (directly or by placing a large flat object on it), with the phone then determining the user's weight based on measured force(s) over the front or back of the smartphone. As with strength measurement, such weight measurements may be provided, when needed to remote healthcare providers (e.g., doctors), such as for use in diagnostics and/or in the course of regular medical checkups. In some instances, the sensory functions may be calibrated when providing such strength or weight measurement, such as using objects of pre-determined weight.

In some instances, similar solutions may be used in other fields, such as robotics and/or in industrial equipment. For example, keypads (such as the ones used in gas stations) may configured to utilize such sensory functions, with the physical keys (or buttons) being replaced with a single surface defining areas corresponding to the traditional keys (e.g., surface that has markings but actually the entire thing is sensitive). Such keypads may then be configured to allow added and enhanced operations based on the sensory functions (e.g., the whole sensitive surface), such as to allow consumer to sign, or provide personalized instructions. Further, the ability to measure strength may allow users to provide input in secure way—e.g., by personalizing the input based on the user's unique strength to allow determining when others (e.g., unauthorized person) are attempting to use the user's information fraudulently.

In an example implementation, enhanced force-touch based gestures and related functions may be configured for use in conjunction with other medical or health related applications. For example, sensory relation functions may be configured to enable use of the electronic device to monitor heart rates. Heart rate monitor via edge or back of bezel against artery or chest respectively (assuming sensor(s) meet necessary sensitivity levels). In this regard, the ability to use the electronic devices in this manner (and/or with other applications) may depend on such factors as level of sensitivity, placement of the electronic devices on the user's body, etc.

For example, different parts of the phones more (or less) sensitive by placing more (or less) sensors, and/or by adjusting the sensitivity of the sensors. Also, different parts of the user's body may be more (or less) suited for obtaining sensory-based readings—e.g., the user's fingertip may be more suited for heartbeat readings than other parts. In another use scenario, sensory relation functions may be used for measuring/tracking blood pressure.

In an example implementation, enhanced force-touch based gestures and related functions may be configured to enable use of such electronic devices to provide customized services (e.g., accessibility options) for users with special needs (e.g., physically challenged users). In this regard, sensory functions (force-touch sensors and related components) may be used to enhance usability and/or accessibility for physically challenged users.

For example, sensory functions may be used to allow scrolling or positioning the cursor on an electronic device's (e.g., smartphone's) screen without touching and/or by using a single hand—e.g., the same one being used to hold the phone, such as by allow the user to scroll when holding the electronic device—e.g., by sliding a finger on one of the edges, or by moving a finger on the back of the electronic device, thus effectively turning the back of the electronic device as a two dimensional touchpad. In an another example use scenario, input may be provided by moving the electronic device (e.g., back and forth, and/or against particular body part, such as the user's knee, or against some other object, such as a the edge of a chair), which may be used when the user is incapable of using his/her hands.

In an example implementation, enhanced force-touch based gestures and related functions may be configured to allow use of particular type of electronic devices (e.g., phones) to function as a different type of electronic device, which may not be available to (or not be desirable for use by the users. For example, enhanced force-touch based gestures and related functions may allow use of smartphones and similar devices as game controllers. In this regard, smartphones or like devices may be configured to operate as game controller for particular game consoles (e.g., Xbox, PS4, etc.), with particular areas on certain sides or edges of the smartphone being configured to function as particular virtual buttons or controls typically used in such game controllers.

In other words, the smartphone (or particularly certain areas on its back, front, edges, etc.) may be configured to emulate buttons on particular game controllers whereby user's interactions with such areas (pressing, sliding, etc.) may be received and handled in similar manner as interactions with buttons on the game controllers. To that end, the smartphone may setup connections to corresponding game consoles to provide the received input/commands. In some instances, these electronic devices may configured in accordance with the user's preferences—e.g., regarding assigning of the virtual “buttons” to particular game controller functions, the manner by which input is provided (e.g., which gestures, etc.).

In an example implementation, enhanced force-touch based gestures and related functions may be utilized to provide enhanced game controllers—e.g., game controllers with force-touch sensors and support for various force-touch based gestures, virtual reality (VR) controllers, etc. For example, game controllers may incorporate enhanced sensory related components and functions (e.g., sensors throughout their surfaces or areas thereof, etc.) to allow users to interact with the game controllers by use of force-touch based actions, in the same manner described above with respect to smartphone and like devices. Such force-touch sensitive game controllers may also be made fully reconfigurable, to allow customization by the users (e.g., grip, button assignment, etc.).

Enhanced sensory related components and functions may also be used in virtual reality (VR) controllers to improve operations thereof. In this regard, VR controllers may incorporate force-touch sensors on to allow users to provide input or commands by gripping the controllers or applying force to particular parts thereof—to allow determining how the users are gripping the controllers, positions where the users are applying forces (e.g., by pressing with their fingertips), and to measure the applied force.

Incorporating enhanced sensory related components and functions into game and/or VR controllers (and/or electronic devices configured to operate as such) may allow providing various functions or services. For example, such controllers may support use of sensory based security operations, such as use of security protection squeeze sequences. Also, such controllers may allow commands or input that may not be available otherwise—e.g., gestures corresponding to “twisting” actions, which may be used in certain gaming scenario (e.g., motorcycle riding. Further, these controllers may be able to determine players' emotional states in ways existing controllers may not be able to do.

For example, the force the users are applying, and measurements thereof), may be used as indications of the level of nervousness or stress the user exhibit while playing, which may be used to control or adjust the games. In addition, because such controllers are not limited by the small number of controls (e.g., buttons and the like) on traditional controllers, and/or by the lack of re-configurability, these enhanced controllers may support larger number of games, and/or operations associated therewith.

In an example implementation, enhanced force-touch based gestures and related functions may be utilized to allow using together (e.g., as one) multiple electronic devices. For example, multiple devices incorporating the enhanced sensory functions may be touched or in contact (e.g., a number of smartphones lined up next to each other) for pairing or other interaction, with the sensory function allowing for interactions between these device while operation together. For example, multiple smartphones (or similar devices) may be put together, such that they could be used as a “single” large display, with particular areas on particular ones of the devices being configured to operate as “virtual” controls (e.g., power, volume, etc.) etc.

In this regard, the sensors allow the devices to determine immediately when they are press up against each other, to determine each device position within the group, and/or to pair the devices. In this regard, pairing via sensory functions obviate the need to utilize wireless connections to pair the devices, or the need to use such connections to communication information between the devices. The sensors allow for suitable communications between the devices. This may be done by use of suitable means in the “transmitting” device that would be received via force-touch sensor in the intended “receiving” device.

For example the “transmitting” device may use embedded or existing vibrating components to “buzz” (e.g., generating sequences of vibrations, of particular characteristics) which may be detected by the sensors of the adjacent “receiving” device. Thus, to pair devices in an example use scenario, users may simply place the devices against each other, and then start an application in the devices, which causes them to issue pre-defined “pairing” buzzes and/or “positioning” buzzes that would be detected by the force-touch sensors, allowing the device to pair up and/or to determine their position (e.g., expresses in terms of x/y position in the group). Such interactions have an added security aspect in that only devices with in physical contact with one another would be able to receive the communicated information. Use of multiple devices may be suitable to allow of use configurations that are particularly desirable, such as provide bendable displays, for example.

In an example implementation, enhanced force-touch based gestures and related functions may be used in existing equipment to enhance operation thereof. For example, force-touch sensory functions may be incorporated into vehicle steering wheels, to obtain force measurement relating to drivers—e.g., measure force applied by drivers while holding the steering wheels. This may be used to enhance operations.

For example, it may be used as in safety control—e.g., sensing loss of grip, which may be construed as an indication of the driver's loss of concentration, such as when the driver is falling asleep or becomes incapacitated. As another example, sensing loss of grip may be used to initiate a self-driving mode in a vehicle that enables manual and self-driving operation.

It may also be used to allow providing input via the steering wheel, thus obviating the need to take hands of the wheel. For example, the steering wheel may be reconfigured to have various controls that allow the drivers to providing input (e.g., relating to controlling functions in the automobile itself and/or devices used in the automobile, such as the driver's phone) simply by adjusting the applied force, the position, etc.

In an example implementation, enhanced force-touch based functions may be used to provide or enable security related gestures and use thereof. In this regard, security related gestures (e.g., sequence of various forces or level of force sequence) may be defined and use to secure the electronic devices and/or various application performed thereby. For example, touch-based interactions, using pre-defined gestures (including particular positions, force levels, etc.) may be used as security input, such as to lock or unlock electronic devices. Security protection squeezes may also be used—that is, where the user's applied force is used as indication of what the user wants (or does not want) done. In this regard, one or both of a user's unique strength and particular squeeze sequences may be used in identifying users, because for example every person would likely have a different force profile (e.g., different maximum levels, etc.) and different sequences established.

Such security solutions may also be applied in machines whose use may particularly raise security concerns, such as ATMs and the like. For example, an ATM machine incorporating such enhanced force-touch based functions may provide added level of security by allowing user to identifying themselves not just by providing pre-set passcodes, but also by specifying different force based interactions (e.g., based on how hard the user pressed the keypad), which would indicate when the intended user is using the machine, and is doing so willingly.

In an example implementation, enhanced force-touch based functions may be used to provide or enable detecting relative position of electronic devices (e.g., relative to the users), with these relative positions associated with particular commands. For example, force detection may allow determining when a smartphone (or like devices) is tilted slightly, which may be interpreted as request for a quick pre-view of a recent activity (e.g., email or webpage, etc.). In an example use scenario, where a smartphone sitting flat on a table is tilted (e.g., based on detection of force applied by the user on the edges or back of the smartphone) after a text message or email is received), such tilting may be detected and interpreted as request for quick review of the text or email.

FIG. 2 illustrates an example force-touch based architecture for use in electronic devices, which may be used in conjunction with enhanced force-touch based gesture solutions. Shown in FIG. 2 is an electronic device 200.

The electronic device 200 may be substantially similar to the electronic device 100 of FIG. 1. The electronic device 200 may incorporate, however, force-touch sensors and may be configured for handling force-touch based interactions. For example, as shown in FIG. 2, the electronic device 200 may comprise a plurality of sensory areas 230 (e.g., 230₁-230₁₀ as shown in FIG. 2) within the body 210 of the electronic device 200, such as along the edges of the screen 220 of the electronic device 200, as illustrated in FIG. 2.

These sensory areas 230 (also referred hereafter as “sensory keys”) may be configured for detecting a user's interactions therewith (e.g., based on touch, press, or the like), to enable handling such interactions—particularly, in manner where such interactions may be used to provide input. In this regard, the electronic device 200 may comprise suitable components and/or circuits for handling generating sensory information (e.g., based on interactions with the sensory areas 230), and/or for processing the generated sensory information, such as to enable interpreting them as user input. These components and/or circuits may be dedicated, specifically added for use in conjunction with the sensory related operations, and/or may comprise existing circuits configured for supporting the sensory related operations.

For example, as shown in the example implementation illustrated in FIG. 2, the electronic device 200 may comprise, underneath the sensory keys 230, corresponding force-touch sensors 240 (e.g., one associated with each sensory key 230, thus 10 force-touch sensors 240₁-240₁₀; but the disclosure is not so limited), which generate signals in response to the application of force (or touch) onto the sensory keys 230. In this regard, the sensory keys 230 and the force sensors 240 may be arranged for enhanced force sensor based operations in the electronic device 200. For example, the keys/force sensors may be arranged in two rows, in close proximity to one another.

Nonetheless, while in the particular implementation shown in FIG. 2, 10 sensory keys 230 are used with 10 corresponding force sensors 240, and with two rows of five on each edge that are each coupled together, it is understood that the disclosure is not so limited, and that less or more keys/sensors may be used and/or may be arranged in different manner, with the solutions and functions described herein being similarly applicable with such changes in numbers and/or exact arrangements.

Further, the electronic device 200 may comprise such circuits for use in conjunction with sensory related operations as an analog-to-digital (A/D) converter 250, a processor (e.g., central processing unit (CPU) 260, a memory 270, and a display output interface 280. In this regard, during example operation, the force touch sensors 240 may generate signals in response to the application of force (or touch) onto the sensory key 230. The A/D converter 250 converts the analog signals generated by the force touch sensors 240 into digital signals that are inputted into the processor 260, which then processes the signals. In this regard, the processor 260 may utilize the memory 170 during such processing operations (e.g., to store and/or retrieve data, to obtain executable code for handling the sensory related signals, etc.). The processor 260 may then act based on processing of the sensory related signals. For example, in response to processing of the sensory related signals, the processor 260 may provide output to the user via the screen 210, which may require use of the display output interface 280.

The electronic device 200, and components thereof, may be configured for supporting enhanced force-touch based gestures and related functions, as described with respect to FIG. 1.

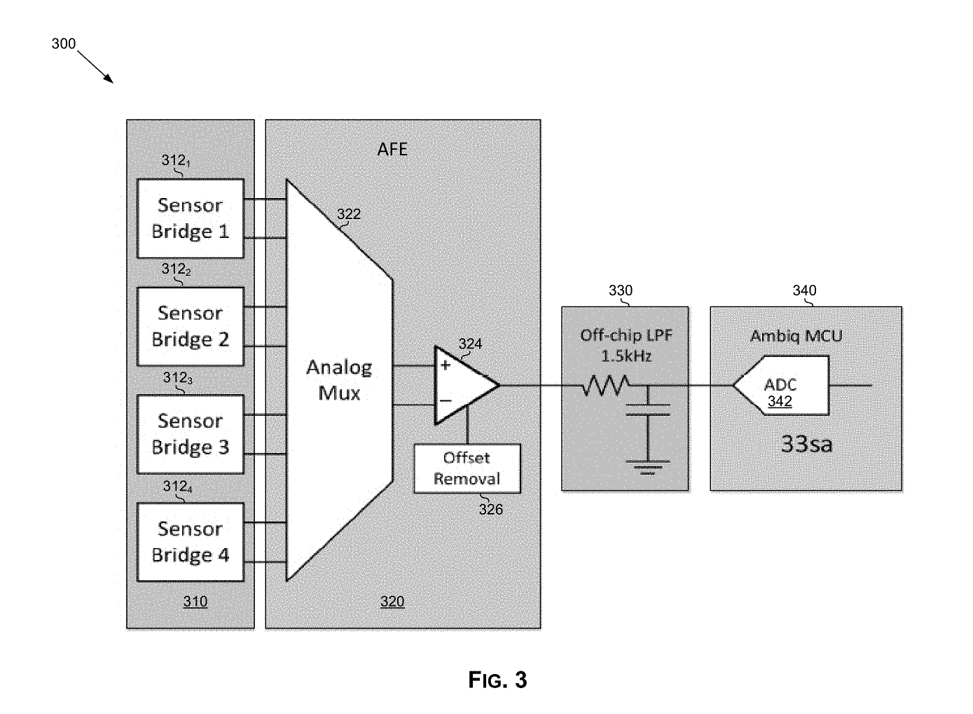

FIG. 3 illustrates an example conventional force-touch (FT) sensor architecture, which may be used in conjunction with enhanced force-touch based gesture solutions. Shown in FIG. 3 is force-touch (FT) sensor architecture 300.

The FT sensor architecture 300 (or portion thereof shown in FIG. 3) comprises a plurality of sensor bridge circuits 312 (e.g., 4 sensor bridge circuits 312₁, 312₂, 312₃, and 312₄ as shown in FIG. 3) embedded within a bezel 310, an analog-front-end (AFE) circuit 320 (e.g., one for each set of bridge circuits, such as 4 bridge circuits as shown in FIG. 3), a low-pass filter (LPF) circuit 330, and a memory controller unit (MCU) circuit 340.

The AFE circuit 320 may comprise an analog multiplexer (MUX) 322 that selects between inputs from the corresponding bridge circuits—thus, in the example implementation shown in FIG. 3, the MUX 322 is a 4-to-1 selector. The AFE circuit 320 also comprises a variable-gain amplifier (VGA) 324 and offset removal circuit 326, which may be used to generate a sensory signal based on the difference between each two pins in one of the bridge circuits—the one selected via the MUX 322.

After filtering via the LPF circuit 330, the sensory signal may be digitized via an analog-to-digital convertor (ADC) 342 in the MCU circuit 340.

Conventional force-touch sensor architectures (such as the one shown in FIG. 3) are implemented using separate and distinct circuits (e.g., on separate die). This may result in timing constraints—e.g., when needing to separately assess each of a number of sensor bridge circuits that are assigned to a single AFE circuit. Thus, in some implementations, other types of force-touch sensor architectures may be used to address some of the possible issues that may arise with conventional solutions, particularly with respect to the delays and costs.

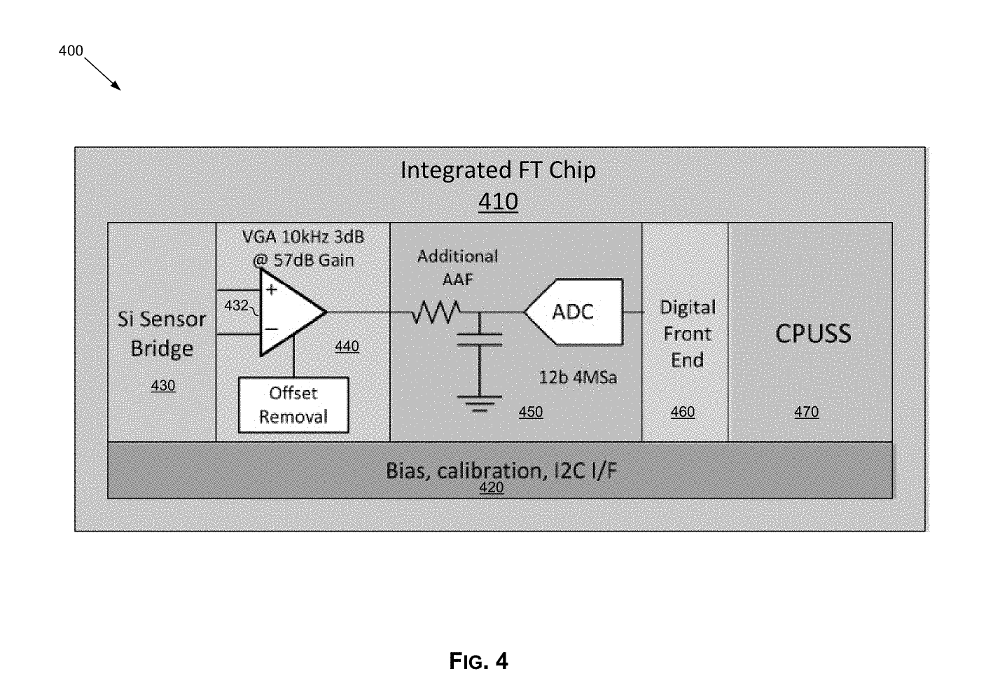

For example, in some implementations, integrated force-touch (FT) sensor architectures may be used. In this regard, integrated force-touch (FT) sensors may be designed for implementation on a single integrated circuit die (or chip) that combines the sensory function (e.g., corresponding to each of the sensor bridge circuits 312 in FIG. 3) with the required processing functions. An example integrated force-touch (FT) sensor architecture is described with respect to FIG. 4.

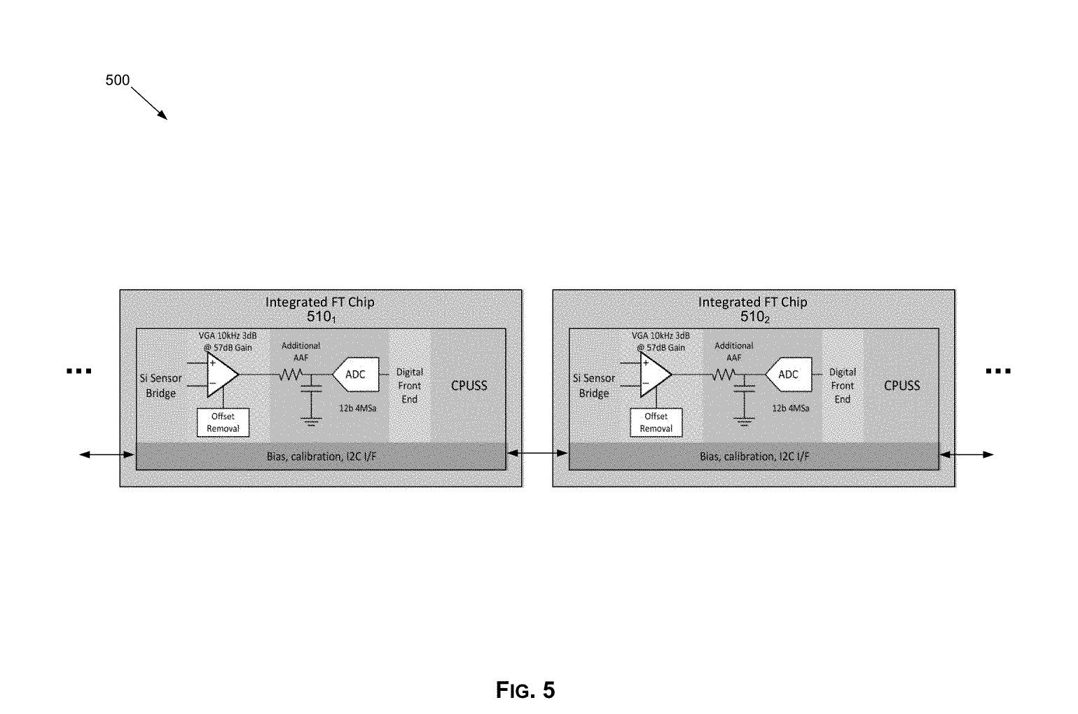

Use of such integrated force-touch sensor architectures may result in reduction in costs and complexity. Further, these integrated force-touch sensor architectures may be configured for concurrent operation of sensor bridges, since each die incorporates the sensor bridge function and its required processing functions, thus further reducing delays, as illustrated in the multi-sensor configuration described with respect to FIG. 5.

In various implementations, electronic devices incorporating FT sensor architecture 300 or sensors based thereon, may be configured for supporting enhanced force-touch based gestures and related functions, as described with respect to FIG. 1.

FIG. 4 illustrates an example integrated force-touch (FT) sensor architecture, which may be used in conjunction with enhanced force-touch based gesture solutions. Shown in FIG. 4 is integrated force-touch (FT) sensor architecture 400.

The integrated force-touch sensor architecture 400 (or portion thereof shown in FIG. 4) is implemented into an integrated force-touch die (or chip) 410, which incorporates all of the required circuits. In this regard, each integrated force-touch chip 410 comprises suitable circuitry for providing the sensor bridge function and all of the related processing functions, with that circuitry incorporated on single integrated circuit die. As noted above with respect to FIG. 3, an integrated architecture may offer various advantages over existing, conventional architectures (such as the one shown in FIG. 3). For example, highly sensitive piezoresistor bridge may be integrated in standard complementary metal-oxide-semiconductor (CMOS). In this regard, the piezoelectric “gauge factor” may determine the sensor sensitivity or resolution.

In particular, p-well and n-well resistors may form very sensitive piezoresistors, and low doping levels (e.g., below 1e18) may result in gauge factors significantly lower than existing sensors (e.g., gauge factors 70 to 150 versus 10 for existing sensors). Further, doping type may determine sign of coefficient, while layout orientation is critical as well. Also, temperature dependence may be easily calibrated out dynamically. In addition, positive-coefficient and negative-coefficient sensors may both be integrated on a single die.

Another advantage is that well resistors are mature passive components in standard CMOS (e.g., 0.18 μm CMOS may be used, due to maturity and lack of restriction on use of existing technologies). Also, lagging-edge processes can be used, resulting in lower cost and leakage (e.g., with 0.18 μm CMOS cost may be less than 1.5 cents per mm²). Also, High-performance/low-power ADCs (e.g., audio grade) can be integrated on the chip. Further, at 0.18 μm, a 30 k-gate MCU may occupy only about 0.35 mm² routed.

Thus, a complete force-touch system can be integrated on a single die—that is, provide a full force-touch (FT) system-on-chip (SoC) that includes a sensor bridge and all related components for the required functions (e.g., AFE, ADC, MCU, etc.), and may incorporate any required software/firmware For example, as shown in FIG. 4, the integrated force-touch chip 410 comprises a local common backbone 420 (for example, providing such functions within the chip as biasing, calibrating, and bus/interfacing, such as in accordance with inter-integrated circuit (I²C) interface), a sensor bridge 430, an initial analog signal adjuster 440 (comprising, e.g., a variable-gain amplifier (VGA) and an offset removal block), a signal converter 450 (comprising, e.g., a low-pass filter (LPF) and an analog-to-digital converter (ADC)), a digital-front-end (DFE) 460, a local central processing unit (CPUSS) 470. Use of such single die system may result in significant cost, power, and performance improvements over existing/conventional solutions.

Integration of all these functions into single die eliminates third party sensors and MCUs while simplifying manufacture, may provide dramatically improved duty cycled power, and may improve signal path sensitivity. The integrated architecture may also allow for and support other uses that may not be possible (or optimal) with existing architecture. Such other uses may include handling and gesture detection across entire phone case. In this regard, array processing of sensor data may allow for triangulating sources of vibration and contact.

In various implementations, electronic devices incorporating integrated force-touch sensor architecture 400 or sensors based thereon, may be configured for supporting enhanced force-touch based gestures and related functions, as described with respect to FIG. 1.

FIG. 5 illustrates an example integrated force-touch (FT) multi-sensor configuration, which may be used in conjunction with enhanced force-touch based gesture solutions. Shown in FIG. 5 is a multi-sensor arrangement 500.

The multi-sensor arrangement 500 comprises a plurality of integrated force-touch chips 510ᵢ (of which, chips 510₁ and 510₂ are shown). In this regard, each of the chips 510ᵢ may be substantially similar to the integrated force-touch sensor chip 410 described with respect to FIG. 4.

As shown in FIG. 5, in an example implementation, integrated force-touch chips in accordance with the present disclosure may be configurable to support multi-sensor arrangement, like the multi-sensor arrangement 500. In this regard, the multiple sensor chips may be daisy-chained, using the common backbone components therein—e.g., I²C bus/interface based connections, with one of the chips (e.g., chip 510₁ in FIG. 5) being designated a master, with the remaining chips being slaves. The master chip may handle data from each sensor—e.g., to compute applied forces and position.

In various implementations, electronic devices incorporating multi-sensor arrangement 500 or sensory functions based thereon, may be configured for supporting enhanced force-touch based gestures and related functions, as described with respect to FIG. 1.

An example electronic device in accordance with the present disclosure may comprise a plurality of force-touch sensors integrated into a body of the electronic device and one or more control circuits. Each force-touch sensor of the plurality of force-touch sensors is configured to generate sensory signals in response to application of a force to an area of the body of the electronic device corresponding to that force-touch sensor. The one or more control circuits may be configured to control, based on sensory signals, one or more operations and/or functions in the electronic device. Each of the operations and/or functions may relate to one or more of a media related application in the electronic device, a health related application in the electronic device, an interactive related application in the electronic device, a communicative related application in the electronic device, and a security related application in the electronic device. The controlling may comprise generating, based on the sensory signals, one or both of control information for controlling or managing at least one of the one or more of operations and/or functions in the electronic device and an input to at least one of the one or more of operations and/or functions in the electronic device.

In an example implementation, the one or more control circuits may be configured to interpret the sensory signals. The interpreting may comprise determining when the sensory signals correspond to one or both of a particular input and a particular value.

In an example implementation, the one or more control circuits may be configured to determine when the sensory signals corresponding to a particular action or a particular sequence of actions by a user of the electronic device against the body of the electronic device, and to set or configure based on the particular action or the particular sequence of actions, one or both of the control information and the input. The particular action or the sequence of actions may comprise one of a double tap, a scroll, an Xswipe, and a multi-finger touch.

In an example implementation, the one or more control circuits may be configured to determine based on the sensory signals, spatial information for the electronic device, and to set or configure based on the spatial information for the electronic device, one or both of the control information and the input. The spatial information may comprise information relating to one or more of placement of the electronic device, positioning of the electronic device, and movement of the electronic device.

In an example implementation, the one or more control circuits may be configured to determine based on the sensory signals, points of contact or no contact on the body of the electronic device, and to set or configure based on the points of contact or no contact, one or both of the control information and the input.

In an example implementation, the media related application may comprise a camera application. The input may comprise aspects for controlling one or both of a mode and operation of the camera application, and the one or more control circuits may be configured to set or configure the input based on characteristics associated with the sensory signals.

In an example implementation, the input may comprise health related data, associated with a user of the electronic device, for the health related application. The one or more control circuits may be configured to determine a value for at least some of the health related data based on characteristics associated with the sensory signals.

In an example implementation, the health related data associated with the user of the electronic device may comprise strength, and the one or more control circuits may be configured to obtain a measurement of user's strength based on the sensory signals.

In an example implementation, the health related data associated with the user of the electronic device may comprise heart related data, and the one or more control circuits may be configured to obtain a measurement of user's heart rate based on the sensory signals.

In an example implementation, the media related application may comprise a gaming application, and the plurality of force-touch sensors and the one or more control circuits may be configured to enable use of the electronic device to simulate a game controller.

In an example implementation, the one or more control circuits may be configured to, when the electronic device is used to simulate the game controller, generate based on the sensory signals, input corresponding to interactions with pre-defined virtual controller buttons corresponding to particular areas on the body of the electronic device.

In an example implementation, the one or more control circuits may be configured to set or modify controlling the one or more operations and/or functions in the electronic device based on the sensory signals, based on user input and/or preferences.

In an example implementation, the handheld electronic device may comprise one or more processing circuits configured to process the sensory signals. The one or more processing circuits may comprise an analog to digital converter (ADC) circuit that may be configured for converting analog signals corresponding to one or more of the plurality of force-touch sensors into digital signals.

In an example implementation, at least one of the plurality of force-touch sensors may comprise an integrated force-touch chip. The integrated force-touch chip may comprise a sensor circuit configured to generate sensory analog signals in response to application of force against an area associated with the integrated force-touch chip, one or more analog signal processing circuits that may be configured to apply one or more signal processing functions to analog signals, and one or more digital signal processing circuits that may be configured to apply one or more digital signal processing functions. The integrated force-touch chip may be implemented on a single integrated circuit die.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A handheld electronic device comprising:
a plurality of force-touch sensors integrated into a body of the electronic device, wherein each force-touch sensor of the plurality of force-touch sensors is configured to generate sensory signals in response to application of a force to an area of the body of the electronic device corresponding to that force-touch sensor;
one or more control circuits configured to:
control based on sensory signals, one or more operations and/or functions in the electronic device; wherein:
each of the operations and/or functions relates to one or more of:
a media related application in the electronic device;
a health related application in the electronic device;
an interactive related application in the electronic device;
a communicative related application in the electronic device; and
a security related application in the electronic device; and
the controlling comprises generating based on the sensory signals, one or both of:
control information for controlling or managing at least one of the one or more of operations and/or functions in the electronic device; and
an input to at least one of the one or more of operations and/or functions in the electronic device.

2. The handheld electronic device of claim 1, wherein the one or more control circuits are configured to interpret the sensory signals.

3. The handheld electronic device of claim 2, wherein the interpreting comprises determining when the sensory signals correspond to one or both of a particular input and a particular value.

4. The handheld electronic device of claim 1, wherein the one or more control circuits are configured to:
determine when the sensory signals correspond to a particular action or a particular sequence of actions by a user of the electronic device against the body of the electronic device; and
set or configure based on the particular action or the particular sequence of actions, at least one of the control information and the input.

5. The handheld electronic device of claim 4, wherein the particular action or the sequence of actions comprises one of: a double tap, a scroll, an Xswipe, and a multi-finger touch.

6. The handheld electronic device of claim 1, wherein the one or more control circuits are configured to:
determine based on the sensory signals, spatial information for the electronic device; and
set or configure based on the spatial information for the electronic device, at least one of the control information and the input.

7. The handheld electronic device of claim 6, wherein the spatial information comprises information relating to one or more of: placement of the electronic device, positioning of the electronic device, and movement of the electronic device.

8. The handheld electronic device of claim 1, wherein the one or more control circuits are configured to:
determine based on the sensory signals, points of contact or no contact on the body of the electronic device; and
set or configure based on the points of contact or no contact, at least one of the control information and the input.

9. The handheld electronic device of claim 1, wherein:
the media related application comprises a camera application;
the input comprises controlling one or both of a mode and operation of the camera application; and
the one or more control circuits are configured to set or configure the input based on characteristics associated with the sensory signals.

10. The handheld electronic device of claim 1, wherein:
the input comprises health related data, associated with a user of the electronic device, for the health related application; and
the one or more control circuits are configured to determine a value for at least some of the health related data based on characteristics associated with the sensory signals.

11. The handheld electronic device of claim 10, wherein:
the health related data associated with the user of the electronic device comprises strength; and
the one or more control circuits are configured to obtain a measurement of user strength based on the sensory signals.

12. The handheld electronic device of claim 10, wherein:
the health related data associated with the user of the electronic device comprises heart related data; and
the one or more control circuits are configured to obtain a measurement of user's heart rate based on the sensory signals.

13. The handheld electronic device of claim 1, wherein:
the media related application comprises a gaming application; and
the plurality of force-touch sensors and the one or more control circuits are configured to enable use of the electronic device to simulate a game controller.

14. The handheld electronic device of claim 13, wherein, when the electronic device is used to simulate a game controller, the one or more control circuits are configured to generate based on the sensory signals, input corresponding to interactions with pre-defined virtual controller buttons corresponding to particular areas on the body of the electronic device.

15. The handheld electronic device of claim 1, wherein the one or more control circuits are configured to set or modify controlling of the one or more operations and/or functions in the electronic device based on the sensory signals, based on user input and/or preferences.

16. The handheld electronic device of claim 1, comprising one or more processing circuits configured to process the sensory signals.

17. The handheld electronic device of claim 1, wherein the one or more processing circuits comprise an analog to digital converter (ADC) circuit configured for converting analog signals corresponding to one or more of the plurality of force-touch sensors into digital signals.

18. The handheld electronic device of claim 1, wherein at least one of the plurality of force-touch sensors comprises an integrated force-touch chip that comprises:
a sensor circuit configured to generate sensory analog signals in response to application of force against an area associated with the integrated force-touch chip;
one or more analog signal processing circuits configured to apply one or more analog signal processing functions; and
one or more digital signal processing circuits configured to apply one or more digital signal processing functions;
wherein the integrated force-touch chip is implemented on a single integrated circuit die.
